(19) United States
(12) Patent Application Publication
(10) Pub. No.: US 2013/0186008 A1
(43) Pub. Date: Jul. 25, 2013

(54) STRUCTURE ENVELOPE REINFORCEMENT

(71) Applicant: Ted Gower, North Palm Beach, FL (US)

(72) Inventor: Ted Gower, North Palm Beach, FL (US)

(21) Appl. No.: 13/725,948

(22) Filed: Dec. 21, 2012

Related U.S. Application Data
(63) Continuation of application No. 10/871,557, filed on Jun. 18, 2004, now abandoned.

(51) Int. Cl. E06B 5/12; E04B 1/92

(52) U.S. Cl. CPC E06B 5/12; E04B 1/92
USPC 52/2.19; 52/203

(57) ABSTRACT

In the event of hurricanes or man-made events causing high wind velocities and flying debris, a window or door material fabric is removably installed to protect the frangible elements of the openings and unsuitably protected portions of the envelope. The barrier has retainers fastened on opposite sides of an opening with a flexible material fabric extending between the retainers. Alternatively, the barrier can be secured directly to the structure providing envelop protection to the structure.

### CROSS-REFERENCE TO RELATED APPLICATIONS

This application is a continuation of U.S. patent application Ser. No. 10/871,557, filed Jun. 18, 2004.

### FIELD OF THE INVENTION

This invention relates to flexible protective barriers which may be temporarily or permanently erected to protect buildings and occupants or other structures from the effects of high velocity winds or shock waves, with associated debris, resulting from natural phenomena, such as wind storms, and man made events, such as, explosive blasts.

2. Description of the Prior Art

As is known by one skilled in the art of protecting buildings and the like from damage caused by missile-like objects that are occasioned by the heavy winds of hurricanes or tornadoes, there are commercially available variations of hurricane protective devices, often called shutters, that fasten immediately over the frangible area to be protected. These devices are typically expensive to purchase, cumbersome, made from stiff, heavy material such as steel and aircraft quality aluminum alloy or occasionally reinforced plastic. Many shutters need to be manually connected and then removed and stored at each threat of inclement weather. Many others require unsightly and difficult-to-mount reinforcing bars at multiple locations. Further, these known shutters are usually opaque, preventing light from entering a shuttered area and preventing an inhabitant from seeing out. Likewise, it is desirable that police be able to see into buildings to check for inhabitants and to prevent looting which can be a problem in such circumstances. Missiles, even small not potentially damaging missiles, striking these heretofore known shutters create a loud, often frightening noise that is disturbing to inhabitants being protected.

There are many patents that teach the utilization of knitted or woven fabric such as netting, tarpaulins, drop cloths, blankets, sheets wrapping and the like for anchoring down recreational vehicles, nurseries, loose soil and the like. Other protection devices use fabric or netting material to cover a unit to be protected. Typically, the device completely covers the unit, and edges of the fabric are fastened to the ground. Examples of fabric-employing devices are shown in the following patents: U.S. Pat. No. 3,862,876 issued to Graves, U.S. Pat. No. 4,283,888 and U.S. Pat. No. 4,397,122 issued to Cros, U.S. Pat. No. 4,858,395 issued to McQuirk, U.S. Pat. No. 3,949,527 issued to Double et al., U.S. Pat. No. 3,805,816 issued to Nolte, U.S. Pat. No. 5,522,184 issued to Oviedo-Reyes, U.S. Pat. No. 4,590,714 issued to Walker and U.S. Pat. No. 5,347,768 issued to Pineda. The U.S. Pat. No. 5,522,184 for example, provides a netting that fits flush over the roof of a building and uses a complicated anchoring system to tie down the netting.

What is needed in the art is a wind, rain and debris protective system, for individual openings, that can be installed during the construction of a building, either on the inside or outside of windows and doors or can be added to existing structures.

### SUMMARY OF THE PRESENT INVENTION

A kit for protecting openings in a structure from penetration by debris, rain, and the force of high wind. The basic kit employs a polypropylene, woven monofilament geotextile material for use in temporary coupling to a structure opening, such as a window opening. The basic kit includes fasteners that secure the material over the opening and, should the opening be breached such as when a window is broken, the material maintains the envelope of the structure.

Alternatively the material can be used in combination with a retainer permanently secured to the structure wherein the material is temporarily placed into the retainer. In a preferred embodiment, the retainer has a flat flange with a channel on one edge and a longitudinal slit. The flat flange is adapted to cooperate with fasteners to connect the retainer to the structure with said channel extending parallel with the openings, and a flexible material with reinforced margins. The reinforced margins include a slide adapted to telescopically engage the channel with the material in the slit whereby the flexible material spans the openings when the slide is secured in the channel.

Thus, an object of this invention is to provide a barrier made from flexible material to protect the weak portions of the structure envelope including but not limited to, EIFS walls, windows, covered sections and openings of a building and the like from the force of wind, rain and impact from wind-borne debris.

Another objective of this invention is to provide the use of a retainer for securing the two opposing edges of a wind barrier material to retainer anchors located so as to form a structure envelope about the openings with the barrier spanning the opening.

Another object of this invention is that it may be sold as an after market kit to be installed on existing structures.

Yet another object of this invention is that it can be included in manufactured components, such as windows and doors, for installation in new or existing structures.

A further object of this invention is that the material fabric can be installed as an integral part of a structure during new construction.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a plan view of a manufactured window with an integral material fabric;

FIG. 1A is a plan view of a manufactured window with an integral material fabric spaced apart from the window pane by a storm bar;

FIG. 1B is a plan view of a manufactured window with an integral material fabric space apart from the window pane by an inflatable bag;

FIG. 2 is a cross section of a structure constructed with the retainer in the enclosed space;

FIG. 2A is a cross section of a structure constructed with a retainer fastened into the header providing a flashing for the window frame;

FIG. 3 is a cross section of a structure constructed with the retainer outside;

FIG. 3A is a cross section of a structure constructed with the retainer fastened into the header providing a flashing for the window frame;

FIG. 4 is a perspective of a window of a structure with a retrofitted material fabric in place;

FIG. 5 is a perspective of a retainer for the material fabric;

FIG. 6 is a perspective of an alternative retainer;

FIG. 7 is a perspective of a supply roll of the material fabric; and

FIG. 8 is a perspective showing the reinforced margin of the material fabric.

### DETAILED DESCRIPTION OF THE INVENTION

This invention contemplates the use of a flexible barrier, preferably a reasonably transparent, woven synthetic textile material that is able to satisfy stringent testing requirements. The flexible material is capable of withstanding high impact loads without bursting, can be disposed in front of a window or door intended to be protected, and anchored on opposing edges by either direct fastening to the walls of the structure or by use of a retainer for anchoring. Once the material is anchored it is able to contain the impact of foreign objects hurled by the high winds.

When the kit is used with a building, for example, the kit may include retainers that are permanently fastened to the top of a window or door and the bottom of the window, door, or opening. The fabric material may then include a flexible rod formed integral with the material along the opposing edges that is slidably secured into the retainer. Alternatively, the fabric may be anchored at the opposed sides of the window or door. Knitted or extruded material can be used if the material itself meets the criteria described later herein.

Although air travels through the material 11, the barrier is approximately 95% closed, and the velocity of wind passing is greatly reduced and passage of rain effectively stopped. The preferred embodiment has interstices such that rain sheets on the barrier or air flow through the barrier is reduced or stopped. For example, the velocity of a 100 mph wind is reduced by approximately 97% by passing through the fabric material 11 of the present invention. The material fabric of the present invention substantially reduces the force of wind passing through the fabric material and also provides protection against wind-borne missiles having diameters of approximately 3/16 inch in diameter or larger. The ability to provide protection from wind forces and solid debris in the form of an envelope structure represents a step forward in this field. Further, the barrier maintains integrity of the structure, even if the frangible portions of the opening are broken.

The use of the barrier allows very large areas with spans of greater than 25 feet to be covered with ease. Thus, most window groupings could be readily protected. This invention is light in weight, easy to use, does not require reinforcing bars, can be constructed in varying degrees of transparency, can be weather tight, is economical, and is capable of dissipating far greater forces without damage than stiff devices. Missiles striking this barrier make very little sound.

The material 11 does not have rigidity but rather is very flexible, which gives several positive features including allowing for ease of storage as by rolling or folding. Also, the material fabrics may be easily installed by sliding the reinforced margins through the channels. The flexible barrier may be placed a distance out from the surface to be protected to prevent window breakage. However, if the barrier is not distanced from the surface from the window, an impact may cause loss of the window, the material maintains the structure envelop to prevent total loss of the building, which typically occurs when the structure envelop integrity is breached and high winds are allowed inside the structure.

In operation, an impacting missile stretches the material fabric until it decelerates to a stop or is deflected. The fabric material has a predetermined tensile strength and stretch that makes it suitable for this application. Said known strength and stretch, together with the speed, weight and size of the impacting missile, all of which are given in test requirements, permit design calculation to ascertain barrier deflection at impact. This deflection is a determinate of the optimum distance that this barrier is to be spaced out from the frangible area to be protected. Other determinates which may be included are additional deflection from wind pressure and from slack from an improper installation.

If the decision is to position the barrier out a distance from a window, the frangible surface need not be great and may be sufficient without the use of a standoff. If the window is proximate the outside wall of the structure, or is a large window, the distance can be ascertained which permits a time of deceleration such that the barrier will stop far stronger impacts than with the heretofore known rigid devices. In simple terms, the missile is slowed to a stop by elasticity as the barrier stretches. The greater the impact, the greater the stretch. Thus the building is not subjected to an abrupt harsh blow as the impact on the shutter is transferred to the building. The energy transfer is much gentler and less destructive than with the rigid devices.

The interstices of the material fabric permit the light to pass through and is reasonably transparent. If transparency is not desirable, the fabric can be made sufficiently dense to minimize or eliminate the interstices. To assure a long life, the material of the fabric preferably would be resistant to the ultra violet radiation, and to biological and chemical degradation such as are ordinarily found outdoors. This invention contemplates either coating the material or utilizing material with inherent resistance to withstand these elements. A synthetic material such as polypropylene has been found to be acceptable. An example of a coated material is vinyl coated polyester. Materials intended to be used outdoors in trampolines, for example, are likely candidates for use in this invention. Black colored polypropylene is most resistant to degradation from ultra violet radiation. Other colors and vinyl coated polyester are sufficiently resistant, particularly if the barrier is not intended to be stored in direct sunlight when not in use.

The material fabric of the instant invention allows air passage through it when dry, albeit at substantially reduced rate. Moisture on the fabric further reduces air passage. An upwind over pressure of 1″ of mercury, which roughly translates into a 100 mph wind, forces air through at 250 cubic feet per minute (cfm) or approximately 3 mph. The amount of air passage depends on the interstice size. If further protection is desired, the polypropylene material may be laminated with a flexible plastic skin.

It is of importance that the material affords sufficient impact protection to meet the regulatory agencies' requirements in order for this to be a viable alternative to other hurricane protective mechanisms. While stiff structures, such as panels of metal, are easily tested for impact requirement and have certain defined standards, fabrics on the other hand, are flexible and react differently from stiff structures. Hence the testing thereof is not as easily quantified as the stiffer materials. However, certain empirical relationships exist so that correlation can be made to compare the two mediums. Typically, the current impact test of certain locales requires a wood 2×4 stud be shot at the barrier exerting a total force of approximately 230 pounds, or 61.3 pounds per square inch (psi), over its frontal (impacting) surface. This impact and resultant force relate to the Mullen Burst test commonly used by manufacturers to measure the bursting strength of their fabrics. Thus the impact test heretofore used on rigid devices will work equally well on this flexible device.

The preferred embodiment of this invention would use a textile having at least a burst pressure of 675 psi or a total of 2,531.25 pounds over the same 3.75 square inch frontal surface of the nominal 2×4 test missile and would stretch 21% immediately prior to failure. The strength and stretch characteristics of the material are known. The strength of this fabric is more than eleven (11) times the 230 pounds of strength required to withstand the above-described 2×4 missile test as presently required by said regulatory agencies. Stronger fabrics are available. Others are available in various strengths, colors and patterns.

In the alternative embodiment, the use of flexible fabric material distanced out from the frangible area as a protective barrier allows extended deceleration. When the strength and stretch properties of the fabric are known and allowed for, the extended deceleration becomes controlled.

The material fabric 11 of this invention is easy to install, requires low maintenance and has low acquisition cost. There is much flexibility with storage. It is preferable but not essential, that the material selected to be used in the material fabric of this invention be inherently resistant to elements encountered in the outdoors or can be coated with coatings that afford resistance to these elements. A suitable material is polypropylene formed in a monofilament and woven into a geotextile (style 20458) manufactured by Synthetic Industries of Gainesville, Ga. The fabric is woven in a basket (plain) weave as shown in FIG. 5 where the fill and warp threads alternately cross over and under adjacent fills and warps. In the preferred embodiment the interstices are substantially equal to 0.6 millimeters. In the basic embodiment, the interstices allow the insertion of a fastener such as a tapcon screw without damage to the material. The interstices move to allow insertion of the fastener screw without damage to the material.

The material selected must meet certain strength criteria. These criteria, together with the size of span covered by the barrier, constitute the basis for calculating the deflection of the barrier. Said deflection is calculated as follows:

1) The fabric must be sufficiently strong that the impact force it is required to withstand is less than the failure force (Mullen Burst).

2) The impact (test) force is then divided by the force required to cause failure (Mullen Burst). This quotient is then multiplied by the known stretch at failure to obtain the stretch factor. The woven polypropylene synthetic fabrics of the type used in the preferred embodiment stretch 20-22% just prior to failure, depending on manufacturing technique. This stretch information is available from the manufacturer.

3) The actual stretch measurement is then calculated and in conjunction with the span of the barrier used to ascertain the maximum deflection.

### Example

The preferred embodiment is used as an example to demonstrate this formula. The preferred embodiment is a polypropylene, woven monofilament geotextile. The individual filaments are woven into a basket weave network and calendered so that the filaments retain dimensional stability relative to each other. This geotextile is resistant to ultra violet degradation and to biological and chemical environments normally found in soils. This fabric is often used as the mat for outdoor trampolines and is intended to be very resistant to weathering. The fabric is known to stretch a maximum of 21% prior to failure and requires a force of 675 psi to fail.

1. The present test that was originally legislated by Dade County Florida and may become the standard in the industry, requires the barrier to withstand a force of only 61.3 psi. Consequently the fabric meets and exceeds the first requirement of strength.

1. The stretch factor calculation is (test load/maximum load×% stretch at maximum load=stretch factor) 61.3/675×21=1.9%. This becomes a constant factor insofar as this fabric and the Dade test remain involved. The calculation will change if any one or more of the strength, energy or stretch characteristics of the test or fabric are modified Likewise, it is known that stretch varies directly with force up to the maximum at failure. To calculate the actual stretch, the calculation is stretch factor×height=actual stretch. Therefore if the distance between the two fastened sides is eight feet (96 inches), the stretch measurement will be 96×1.9%=1.83″.

2. To calculate the deflection, right triangles are used such that the hypotenuse is ½ of the sum of the height plus stretch (97.83/2=48.92″). The known side is ½ of the height (96/2=48″). Thus the deflection=the square root of the difference between the square of the hypotenuse less the square of the known side. This result is 9.4″ which is the maximum deflection on impact by test missile.

3. Thus the barrier will deflect at least 9.4 inches if an eight (8) foot span is to be used. A longer span will require wider spacing, a shorter will require less. The table shown below reflects this deflection for various sample distances of span with this preferred fabric.

Table demonstrating relationship between Span and Maximum Deflection if spacing apart from a window is preferred.

| Height | Deflection |
|---|---|
| 8 feet | 9.4 inches |
| 10 feet | 11.8 inches |
| 12 feet | 14.1 inches |
| 14 feet | 16.5 inches |
| 16 feet | 18.8 inches |
| 18 feet | 21.2 inches |
| 20 feet | 23.5 inches |
| 22 feet | 25.9 inches |
| 24 feet | 28.2 inches |
| 30 feet | 35.2 inches |
| 40 feet | 47.0 inches |

*The deflection may be interpolated for windows and doors of lesser or greater length.

As the deflection is intended to be minimum, and although the barrier is intended to meet or exceed test standards as opposed to warranting protection in actual situations which are difficult to predict, this invention can include an additional factor in the deflection to allow for maximum wind pressure. Arbitrarily assuming a 115 mph wind at 90 degrees to the barrier and assuming the barrier has been made weather tight with no air flow through the barrier to somewhat relieve pressure, and assuming the barrier is installed at sea level where air is densest, the additional pressure on the barrier will be 0.237 pounds per linear inch of span. This additional pressure can be resolved into a vector and added directly to the test force of 61.3 pounds. Thus an 8 foot barrier will have an additional (0.237×96=) 22.75 pounds added for a total of 84.05 pounds. A 40 foot barrier will have (0.237×480=) 113.76 pounds added for a total of 175.06 pounds. This number should be substituted into the above formula to give a more accurate calculation of deflection.

For example: an 8 foot barrier could deflect 10.9″ when allowing for a 115 mph wind factor rather than 9.7″ if the wind was not factored in. The deflection of a 40 foot barrier becomes 80.28″ (6.69°) rather than 47″ (3.9°). If the window is not necessary to salvage, deflection is not of concern as the fabric material will prevent loss of envelop integrity.

The fabric must be anchored in a suitable manner so as to absorb the loads without being torn from its support. While various hardware devices may be used to anchor the fabric in place, general criteria include stainless steel screws or nails 13 with sufficient pull out strength in both wood and concrete to withstand the stress created by the material fabric 11. These criteria are merely exemplary and not limiting. Other anchoring hardware may be used to install the protective barrier of this invention.

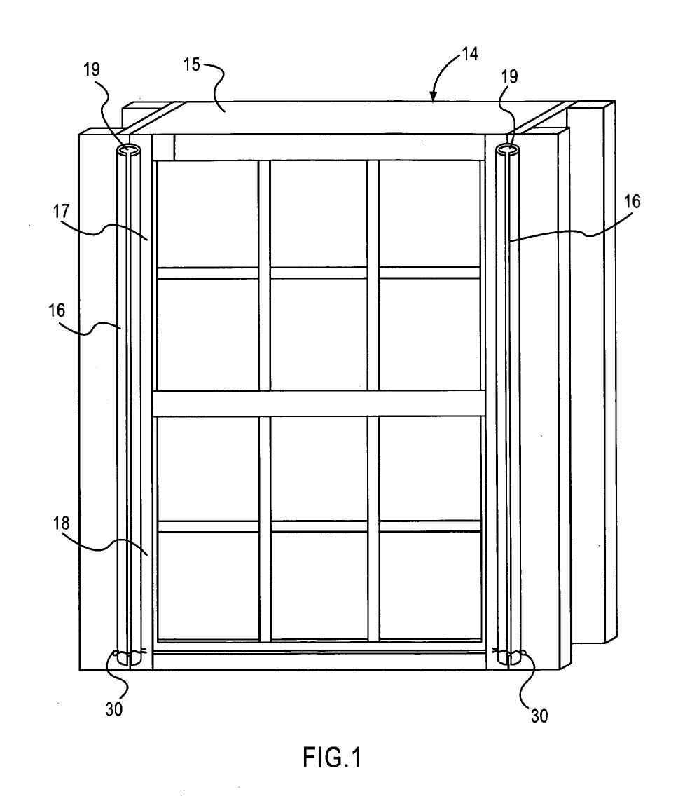

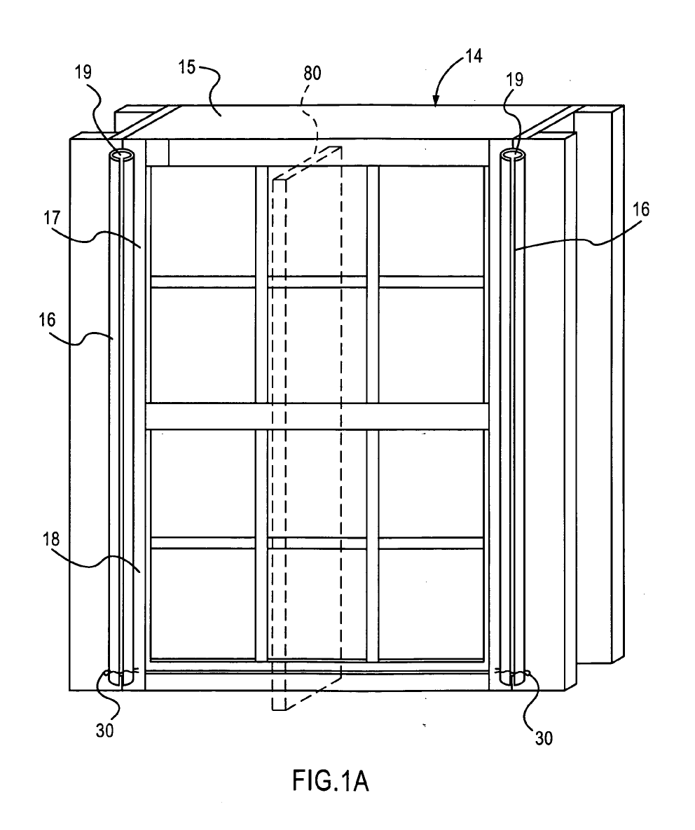

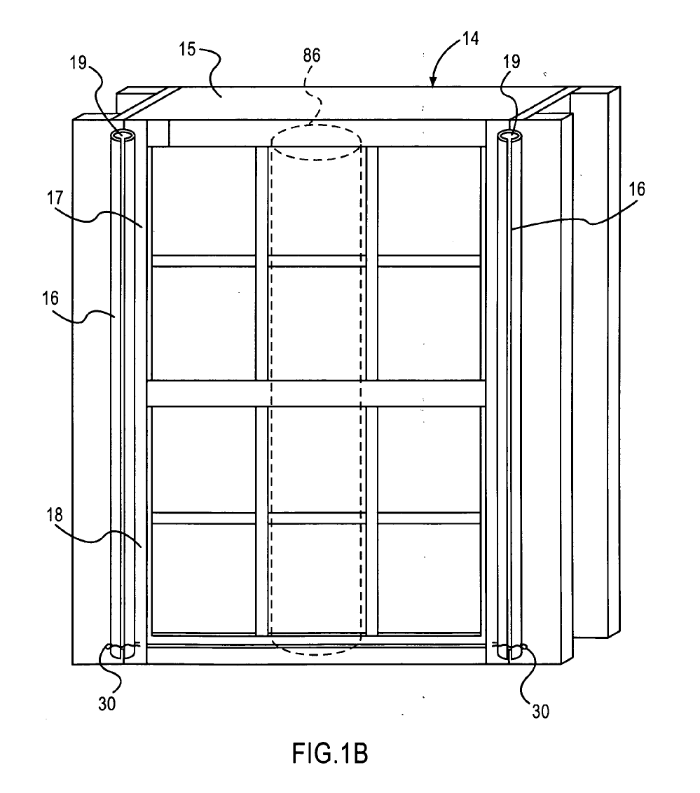

In FIG. 1, a manufactured window 14, for use in new construction or as replacement in existing structures, is shown. The frame 15 is of a size to fit into a standard sized opening in a structure, such as a house or commercial building for habitation or business. The frame 15 includes the structural framework to connect the window to the structure within the opening. As illustrated, the retainer 16 is integrally connected to the window between the frame 15 and the window sashes 17 and 18. During manufacture of the window, the retainer 16 is fastened to the casement by screws or nails before final assembly. Alternatively, the retainer may be attached to the outer edge of the casement so that the channel 19 is disposed between the edge of the opening and the outer edge of the casement. When the embodiment is in the vertical position, the use of a locking hasp 30 prevents the fabric material from sliding out of the retainer channel. FIG. 1A depicts the use of a rigid stand-off 80 that can be made of wood, aluminum or the like material. For instance, a 1″ by 6″ rigid material may be used to span an opening to maintain the material a fixed distance from the opening. Similarly, as depicted in FIG. 1B, an inflatable structure 86 may be placed over the opening to maintain the material a fixed distance from the opening. The inflatable structure can be a nylon or the like material that is easily stored and when needed can be inflated by the material covering to provide a spacing for protection of the opening.

In FIG. 4, the manufactured window is shown installed in a building wall 40. In this embodiment, the flat flange is attached to the outer surface of the frame 15 by fasteners 41.

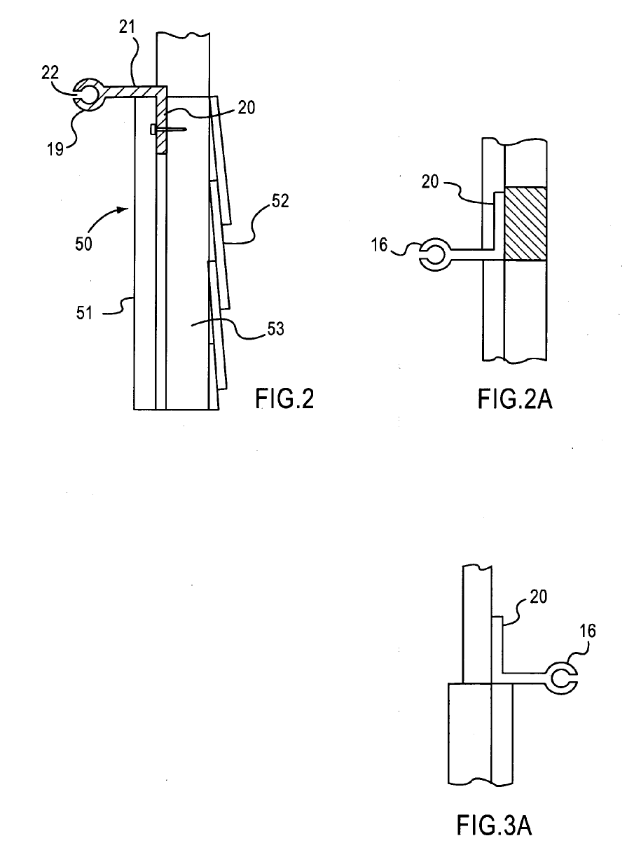

In FIG. 2, the barrier is shown as a part of the original construction of a new building 50, or otherwise integrated into the building facade. The building has an inner wall 51 and an outer wall 52. The inner and outer walls are joined through an intermediate structural component 53 and a window 54. The material fabric 11 is to be mounted in the enclosed space of the building with the flat flange 20 permanently connected to the intermediate component 53 between the intermediate component and the inner wall 51. FIG. 2A depicts the retainer 16 with the flat flange 20 inverted which works as a flashing by attachment to the header.

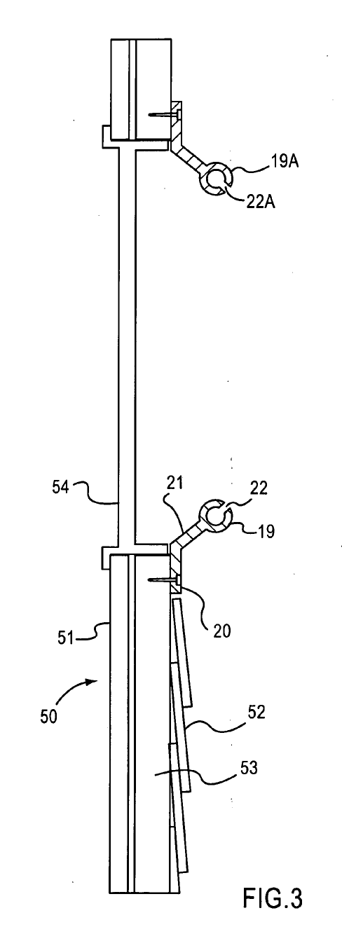

In FIG. 3, the building is constructed with the channel 19 on the outside of the frangible element and the flat flange 20 is permanently connected to the intermediate component between the intermediate component and the outside wall. In this embodiment, the flat flange 20 is formed with an angular extension 21 positioned either upward with channel 19 extending over the top of the opening or in a downward slope as depicted by channel 19A wherein the longitudinal slit 22A is placed over the opening for better drainage of water.

FIG. 3A depicts the retainer 16 with the flat flange 20 inverted which works as a flashing by attachment to the header, the angle further provides for water drainage.

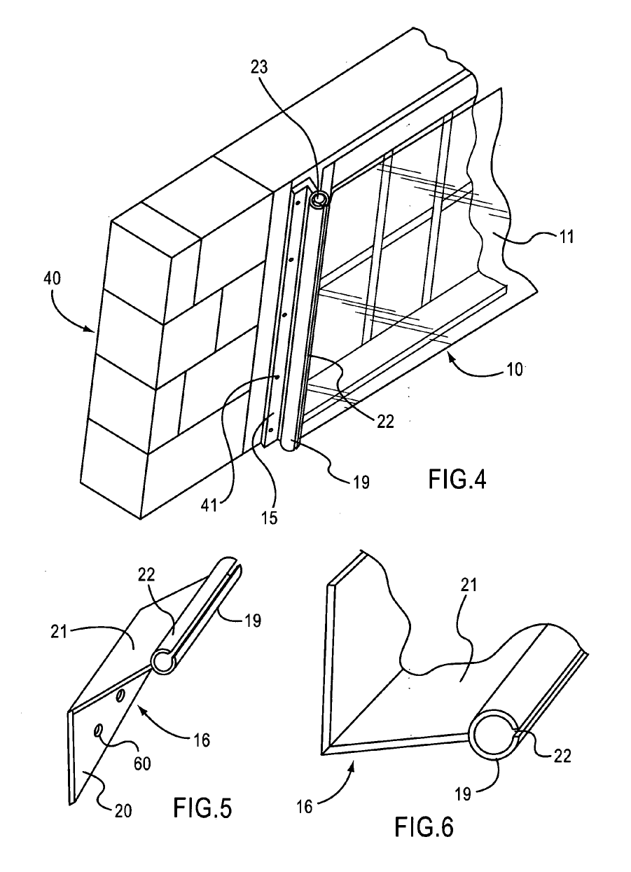

The retainer 16, shown in FIGS. 5 and 6, is formed of a flat flange 20, an angular extension 21 and a channel 19. The channel 19 has a longitudinal slit 22. The retainer may be made of various materials with the requisite strength and durability to withstand the conditions of use, such as stainless steel or aluminum. Polymers of the requisite strength may also be used. Preferably, the retainer, flange and channel are of one piece construction though modular construction may be used. As mentioned above, the retainer must withstand the stress generated by the material fabric 11 when under load. The flat flange 20 may be made with apertures 60 for the attaching screws or the holes may be drilled on site or the screws or nails may be punched through the flange. The angular extension 21 may be made in different configurations to accommodate the different installations required by building design. In FIG. 5, a 45 degree angle is shown and, in FIG. 6, a 90 degree angle is shown. Of course, there may be other designs, such as, straight, U-shaped or Z shaped and the angular extension may be bent or deformed, on site. The angular extension functions to align the barrier 10 with the perimeter of the opening shown in FIG. 4, either top and bottom or side to side, and to provide spacing for deflection of the material fabric.

The channel 19 cooperates with the bead 23 to connect the retainer 16 and the material fabric 11. The slots 22 may be oriented in the channels to face each other across the span of the material fabric 11. This places the strain directly on the selvedge edge of the material fabric, the joint with the bead, and the opposite edges of the slots 22. In the alternative, the slots may be rotated at an angle from each other so that the material fabric engages one edge of each slot continuously and reduces the strain on the selvedge and the bead.

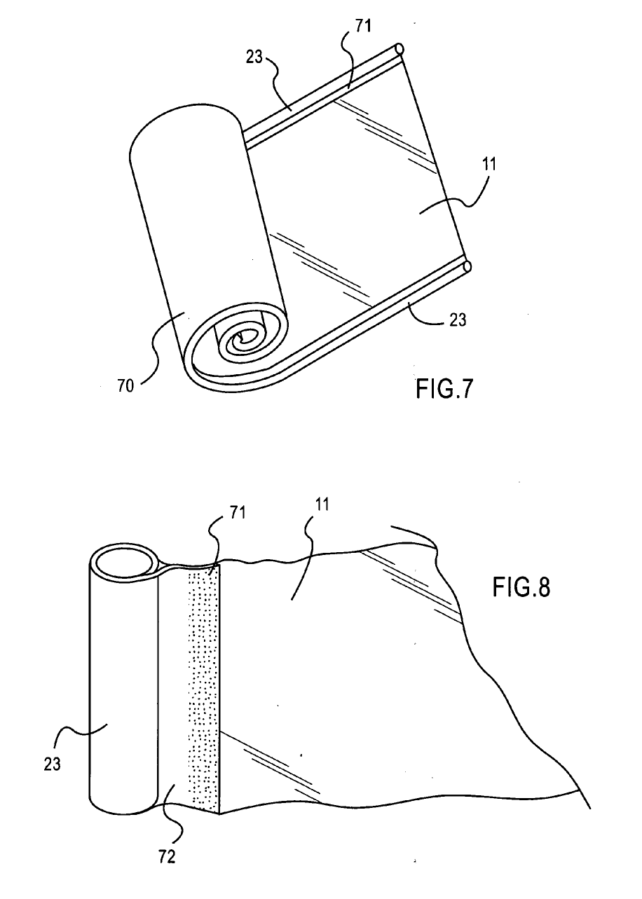

In FIGS. 7 and 8 the material fabric 11 is illustrated. The material fabric 11 is flexible enough to be stored as a roll 70 or a series of rolls. The material fabric must be bendable to permit the ends of the beads to be threaded into the ends of the channels. The beads are then slid through the channels to cover the windows or doors with the material fabric. The material fabric has a selvedge edge 71 that may be folded over on itself, have a reinforcing tape sewn along the edge, or some other form of bonding to secure the edges. In addition to a selvedge edge, a reinforcing tape may be used. The bead 23 is bonded, sewn, stapled or otherwise fixed to the selvedge edge of the material fabric. The bead 23 may be metal or plastic with a continuous extension 72 intimately connected with the edge of the material fabric.

Depending on whether the barrier is purchased as part of new construction, or part of manufactured components, or as after market improvements, the end result places the retainers along two opposed sides of windows and/or doors, either inside or outside the building. The material fabrics are supplied either pre-cut to size or in a supply roll. Once the building is finished or the retainers installed, the sized material fabrics can be removably mounted quickly. The opposite beads are threaded into the opposed channels of the retainers and the material fabrics are slid into position covering the frangible elements of the doors and windows.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A manufactured window casing for installation in a structure including frangible material spanning the casing comprising:
retainers connected to opposed sides of the casing, each of the retainers including a flat flange with a channel member along one edge, the channel member having a longitudinal slit, the flat flange of each of the retainers being connected to the casing by permanent fasteners such that the slit is parallel to the opposed sides; and
a flexible material removably mounted in the retainers, the flexible material formed of a polymer having interstices, the interstices of a size to reduce an upwind wind speed of approximately 100 mph to a downwind wind speed of approximately 3 mph, the flexible material having opposed margins, the margins being reinforced with a connector integrally bonded to the material, the connector having a bead parallel to the margins, the bead slidably inserted into the channel with the material extending through the slit whereby the material spans the frangible material.

2. The manufactured window casing of claim 1, wherein the retainer includes an angular extension between the flat flange and the channel, and wherein the angular extension displaces the channel from the frangible material, whereby the flexible material can flex.

3. The manufactured window casing of claim 1, further including a standoff for spacing the flexible material a fixed distance from the opening.

4. The manufactured window casing of claim 3, wherein the standoff is formed from rigid material.

5. The manufactured window casing of claim 3, wherein the standoff is formed from an inflatable material.

6. A habitable structure having an inside wall defining an enclosed space and an outside wall, a supporting shell between the inside wall and the outside wall, the inside wall and the outside wall attached to the shell, the inside wall, the shell, and the outside wall having at least one congruent opening therethrough, comprising:
retainers connected to the opposed sides of the opening, each of the retainers composed of a flat flange with a channel member along one edge, the channel member having a longitudinal slit, the flat flange of each of the retainers connected to the shell by permanent fasteners with the slit parallel to the opposed sides; and
a flexible material removably mounted in the retainers, the flexible material formed of a polymer having interstices to permit air flow through the material, the air flow of approximately 250 cfm at a pressure of 1 inch Mercury, the flexible material having opposed margins, the margins reinforced with a connector integrally bonded to the material, the connector having a bead parallel to the margins, the bead slidably inserted into the channel with the material extending through the slit whereby the material spans the frangible material.

7. The habitable structure of claim 6, wherein the retainers are connected to the shell between the shell and the inside wall.

8. The habitable structure of claim 6, wherein the retainer includes an angular extension between the flat flange and the channel, the angular extension displacing the channel from the opening whereby the flexible material can flex without penetrating the opening.

9. The habitable structure of claim 6, wherein the retainer is formed integral with a manufactured component of the habitable structure.

10. The habitable structure of claim 6, including a standoff for spacing the flexible material a fixed distance from the opening.

11. The habitable structure of claim 10, wherein the standoff is formed from rigid material.

12. The habitable structure of claim 10, wherein the standoff is formed from an inflatable material.
